(19) United States
(12) Patent Application Publication
(10) Pub. No.: US 2003/0018451 A1
(43) Pub. Date: Jan. 23, 2003

(54) System, method and computer program product for rating enterprise metrics

(75) Inventors: James A. Sullivan, Broomfield, CO (US); Adam S. Rossi, Broomfield, CO (US)

Correspondence Address: MERCHANT & GOULD PC, P.O. BOX 2903, MINNEAPOLIS, MN, 55402-0903, US

(73) Assignee: Level 3 Communications, Inc.

(21) Appl. No.: 09/904,501

(22) Filed: Jul. 16, 2001

(51) Int. Cl. G06F 17/60; G06F 11/30

(52) U.S. Cl. 702/182; 705/1

(57) ABSTRACT

A system, method, and computer program product for assessing the reliability of an enterprise metric. The metric is assessed with respect to one or more key factors, such as the prevalence of manual processing in producing the metric, or mathematical stability of the process of producing the metric. Assessment of the metric with respect to a key factor yields a numerical score for that factor. If the metric is assessed with respect to several key factors, the assessment yields several factor scores, one for each key factor. An overall final, weighted numerical assessment for the metric is created by combining the factor scores. This overall final, weighted numerical assessment of the metric provides the enterprise with a level of confidence in its information used in decision support.

### BACKGROUND OF THE INVENTION

1. Field of the Invention

The invention described herein relates to management practices, and in particular to the use of statistical metrics in management of an enterprise.

2. Background Art

A manager of any enterprise relies on information in order to make decisions. Much of the required information may be statistical in nature. The manager of a manufacturing organization, for example, needs to know the statistical information relating to the level of output and the amount of resources consumed. A sales manager needs to know the amount of available inventory, the amount and types of products sold, and the productivity of each member of the sales team. In general, the manager of an enterprise needs to know, statistically, how the organization is performing and why, in order to be able to maintain or improve performance. Because such statistics represent measurements, they can be viewed as enterprise metrics.

A prudent manager will question the reliability of such metrics. The operations of information collection and processing may be of concern. Is the source historically reliable, for example? Could there have been any human error? If mathematics was involved, was the formulation correct? A metric can be questioned on any of these (or other) grounds.

Often, however, such assessment of a metric is ad hoc, performed without objectivity or rigor. The manager may not have any fixed standard as to how reliable a metric needs to be. Moreover, such an assessment may not be complete. The manager may question some aspect of the metric while ignoring others, and may decide whether or not to use it on the basis of this limited assessment. The result is reliance on metrics of uncertain validity. This introduces risk into any decisions that are based on such a metric.

In addition, the failure to thoroughly assess a metric encourages the reporting of potentially faulty information. If an organization routinely generates metrics that are never questioned rigorously, there is no incentive to improve the way metrics are generated. Questionable information reporting processes continue, and information that is fed to management—the information used in decision-making—never improves.

Therefore a well-defined, rigorous, quantitative, and objective methodology is needed for assessing the metrics that an enterprise generates and relies upon for decision-making purposes.

### BRIEF SUMMARY OF THE INVENTION

A system, method, and computer program product is presented for assessing the reliability of an enterprise metric. The metric is assessed with respect to one or more key factors, such as the prevalence of manual processing in developing the metric, or the mathematical stability of the metric development process. Assessment of the metric with respect to a key factor yields a numerical score for that factor. If the metric is assessed with respect to several key factors, the assessment yields several factor scores, one for each key factor. In an embodiment of the invention, the key factors include the data source for the metric, the role of business rules in deriving the metric, the use of manual processing, the mathematical stability of the metric generation process, the integrity of metric data, and the historical availability of supporting detail. An overall final weighted numerical assessment for the metric is created by combining the factor scores.

The invention can be embodied in software, hardware, or a combination thereof. In an embodiment of the invention, a user assesses the metric with respect to each key factor, and enters the assessment(s) into a computer. The computer then processes the information to produce a final weighted numerical assessment.

The foregoing and other features and advantages of the invention will be apparent from the following, more particular description of a preferred embodiment of the invention, as illustrated in the accompanying drawings.

### BRIEF DESCRIPTION OF THE DRAWINGS/FIGURES

FIG. 1 is a flowchart illustrating the general method of an embodiment of the invention.

FIG. 2 is a flowchart illustrating the steps of assessing a metric according to a set of key factors, according to an embodiment of the invention.

FIG. 3 is a flowchart illustrating evaluation of the data source of a metric, according to an embodiment of the invention.

FIG. 4 is a flowchart illustrating evaluation of the clarity of business rules and the rules' role in development of a metric, according to an embodiment of the invention.

FIG. 5 is a flowchart illustrating evaluation of the role of manual processing in production of a metric, according to an embodiment of the invention.

FIG. 6 is a flowchart illustrating evaluation of the mathematical stability of a metric, according to an embodiment of the invention.

FIG. 7 is a flowchart illustrating evaluation of the data integrity of a metric, according to an embodiment of the invention.

FIG. 8 is a flowchart illustrating evaluation of the supporting detail of a metric, according to an embodiment of the invention.

FIG. 9 is a diagram showing the computing environment of an embodiment of the invention.

### DETAILED DESCRIPTION OF THE INVENTION

A preferred embodiment of the present invention is now described with reference to the figures, where like reference numbers indicate identical or functionally similar elements. Also in the figures, the left-most digit of each reference number corresponds to the figure in which the reference number is first used. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of other applications.

### Table of Contents

I. Terminolgy

II. Overview

III. Processing

A. Data source

B. Business rules

C. Production process

D. Mathematical stability

E. Integrity

F. Supporting detail

G. Composite assessment

IV. Computing environment

V. Conclusion

I. Terminology

Business Rule: A concept underlying the operation of an enterprise. Business rules include but are not limited to definitions of terms and concepts. These definitions are accepted and agreed upon by key persons in the company, are generally accepted to be an accurate definition of an item, subject, process, or project, and are only changed through an approved change-control process. For example, in a retail environment, a business rule may be the definition of the term “customer.” Is a customer a person who enters a store, or a person who enters and makes a purchase? A particular usage must be chosen, i.e., a business rule regarding the definition must be established, for purposes of managing the business. Ideally, a metric is developed in a manner that reflects relevant business rules. In the above example, any metric pertaining to the number of customers must then reflect whatever definition is chosen.

Data Integrity: Integrity of source data used to generate a metric, as determined by (1) the recency of a validation process performed on a data storage facility and on the source data itself, and (2) the way in which validation was performed (e.g. automated or manual).

Factor Score: A numerical assessment of a metric with respect to a specific key factor. Key factors that can be used in assessing a metric are described in greater detail in Section II below.

Key Factor: An aspect of a metric, generally relating to how the metric is generated and/or validated, examined in the course of assessing the overall reliability of the metric. In the embodiment described herein, six key factors are used. Examples of key factors include the source of the data used in developing the metric, and the mathematical stability of the metric.

Mathematical Stability: The presence (or absence) of a mathematical formulation for the metric. A metric that is generated using a well-defined, correct mathematical calculation is said to be more stable than a metric generated without a well-defined, correct mathematical calculation.

Metric: A regularly produced piece of business information that can represent a trend or condition of an enterprise. One example of a metric, taken from the retail setting, might be the number of customers serviced by a given store in a given month.

Run: A method or mechanism with which a metric is generated. In some environments, a run is a computerized process that generates the metric.

Supporting detail: Detailed information used to derive a metric. This information may have been available regularly (or irregularly) over a period of time. Longstanding, regular availability of supporting detail suggests that the supporting detail is reliable, further suggesting the reliability of a metric that is generated using it. A metric relating to operating expenses of a business may, for example, require manpower costs as supporting detail since manpower costs are a component of expense. Manpower costs may have been generated and recorded on a monthly basis. Manpower costs would therefore represent supporting detail that has been historically generated on a regular basis. Supporting detail is sometimes known as historical detail or historical data.

Validation: Validation refers to checks that are made as to the logical and statistical consistency of the information (both data and business rules) used in generating the metric. Generally, validation of a metric suggests greater reliability of the metric.

II. Overview

The invention described herein represents a method by which a metric generated in the course of managing an enterprise can be assessed for reliability. One example of a metric, taken from the retail setting, might be the number of customers serviced by a given store in a given month. Another example, taken from an industrial setting, might be the mean time between failures (MTBF) of a particular piece of factory equipment. An example from the human resources setting might be the average number of sick days taken by an employee per year.

In the method of the invention, a metric is assessed with respect to one or more key factors. These factors can include, but are not necessarily limited to, the extent to which the metric generation is manual, and the use of a well-defined mathematical formulation in generation of the metric. Additional examples are detailed below. Assessment of the metric with respect to any key factor yields a numerical score for that factor. When the metric is assessed with respect to several key factors, the assessment yields several factor scores, one for each key factor. An overall weighted confidence score for the metric is created by combining the factor scores. This score is the final weighted numerical assessment.

The invention is motivated by the concept that greater confidence in decision-making tools creates better decisions. In the business world, better decisions in turn result in lowered risk to corporate capital.

The invention creates confidence in decision-making by scoring metrics on a level, objective platform. The score can then be translated into logical business decisions. Users of the metrics can better decide which utilities to use in management and decision support. This invention also identifies key aspects of the metric that must be improved to make it more useful to the enterprise and its managers.

One type of decision that may be made using metrics is capital expenditure. Based on a $1 million investment, a decision on bad information could cause a corporation $2 million in lost capital. A manager might invest the capital in a first location, and would see no real return on the investment because the capital was needed at a second location. We would then need to invest in the second location, but the delay could cost most of the advantage that might have been gained from a proper initial investment.

Generally, given an investment decision based on a set of metrics, an enterprise risks a smaller percentage of its capital in each investment if the metrics are relatively stable and valid. This is true for two reasons. First, a more reliable metric will enable a better decision, thus risking a smaller portion of the initial investment. Second, if an errant decision results in an improper investment, more stable and accurate metrics will help identify the error sooner, enabling quicker correction and a reduced loss.

The process of the invention is illustrated generally in FIG. 1. The process begins with step 105. In step 110, a particular metric is identified for assessment. In step 115, the metric is assessed according to each of one or more key factors. In step 120, factor scores generated by the key factor assessment step 115 are combined in a weighted total. This yields an overall score that represents a final weighted numerical assessment for the metric. The numerical assessment offers insight into the reliability of the metric. As will be described in greater detail in Section II, a higher score suggests a more reliable metric. In step 122, the final weighted numerical assessment is output. Output can be routed to a display or other input/output (I/O) device for human access. Alternatively, output can be sent to a memory medium for storage, or to another automated process where it can be used as an input. The process concludes at step 125.

III. Processing

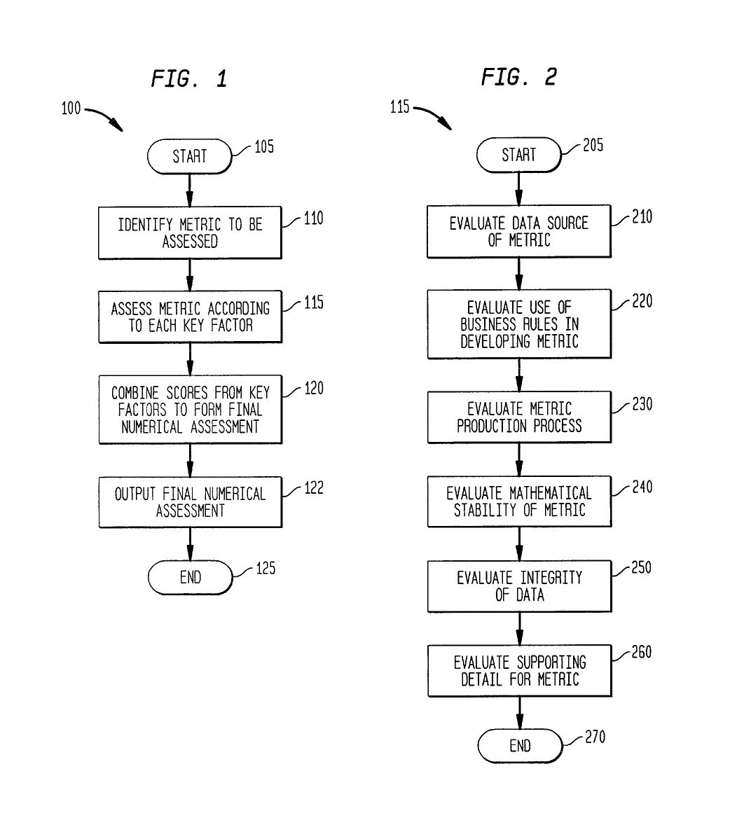

This section describes the process of the invention in greater detail. An embodiment of step 115 above is illustrated more fully in FIG. 2. This embodiment includes the assessment of the metric with respect to each of six key factors. Each key factor is described briefly here and will be described subsequently in greater detail.

The metric assessment process begins with step 205. In step 210, the data source of the metric is evaluated. Step 210 entails consideration of the reliability of the data source. If, for example, the data is collected by a computer system, the reliability of the computer system must be assessed. A more reliable computer system suggests a more reliable metric. In step 220, the use of business rules in developing the metric is evaluated. This step considers the presence of well-defined business rules and the extent to which such rules are reflected in the metric development process. If such rules are in place, a more reliable metric is implied. In step 230, the metric production process is evaluated. This step considers the extent to which human actions are used in generation of the metric. The presence of manual processing suggests a less reliable metric; conversely, a greater reliance on automation suggests a more reliable metric. In step 240, the mathematical stability of a metric is evaluated. This step considers whether a mathematical calculation is used in generating the metric. If so, the metric is generated with some degree of objectivity and precision, and is generally more reliable. In step 250, the integrity of the data is evaluated. This step considers whether validation of the data has been performed, and if so, whether or not the validation has been performed recently. In step 260, the presence or absence of supporting detail for the metric is evaluated. Here, a determination is made regarding the length of time for which valid supporting historical detail is available. Process 115 concludes with step 270.

While six specific key factors are addressed in the embodiment described herein, alternate embodiments of the invention can use a greater or lesser number, and can use key factors other than those identified here. In addition, alternative embodiments can consider the key factors in a different order than that described above. Moreover, in an alternative embodiment, some or all of the key factors can be evaluated simultaneously, in parallel.

A. Data source

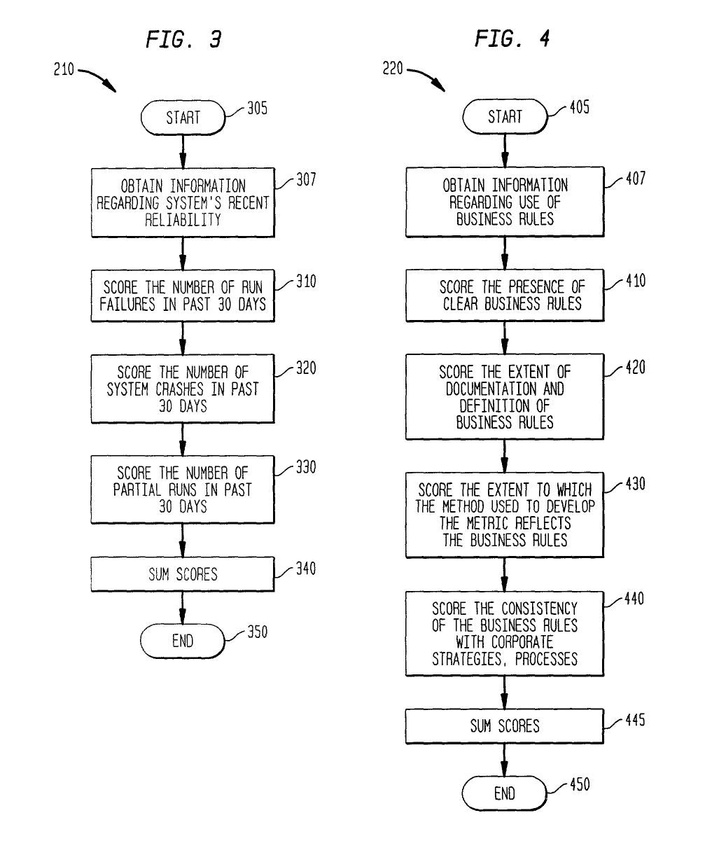

Step 210 above, the evaluation of the data source of the metric, is illustrated in greater detail in FIG. 3 according to an embodiment of the invention. Evaluation of this key factor is particularly appropriate when the metric generation is fully or partially automated, such that the operation of a computer system is being relied upon. Evaluation of a data source starts with step 305. In step 307, information is obtained regarding the computer system's recent reliability, such as the number of recent system crashes and the number of failed or incomplete runs in the past 30 days. If the metric assessment process is automated, the reliability information for this step can be obtained through keyboard entry or through some other I/O device in response to computerized prompts. Alternatively, if the reliability information is archived in a memory medium, the information can be accessed through a network connection or other automated means.

In step 310, a point value is awarded based on the number of run failures in a preceding interval of time. In an embodiment of the invention, the number of run failures in the past 30 days is determined. A higher score is awarded if fewer run failures occur in the interval.

In an example implementation, points for step 310 are allocated as follows:

| Number of run failures, past 30 days | Points awarded |
|---|---|
| 0 | 4 |
| 1 | 3 |
| 2 | 2 |
| 3 | 1 |
| >3 | 0 |

In step 320, a second point value is determined, based on the number of system crashes in some preceding interval of time. In an embodiment of the invention, this interval is the past 30 days. A large number of system crashes in this interval suggests a relatively unreliable system, and an unreliable metric. A larger number of crashes leads to a lower score. In an example implementation, the score for step 320 can be determined as follows:

| Number of system crashes, past 30 days | Points awarded |
|---|---|
| 0-1 | 3 |
| 2 | 2 |
| 3 | 1 |
| >3 | 0 |

In step 330, another point value is awarded based on the number of partial runs in the recent past, e.g., the past 30 days. Fewer partial runs suggests a more reliable system and, therefore, a more reliable metric. A higher score is therefore merited. In an example implementation, the score for step 320 can be determined a follows:

| Number of partial runs, past 30 days | Points awarded |
|---|---|
| 0-1 | 3 |
| 2 | 2 |
| 3 | 1 |
| >3 | 0 |

In step 340, the scores from steps 310 through 330 are summed. This produces a factor score with respect to the data source of the metric. The process concludes at step 350. Note that in alternative embodiments of the invention, steps 310 through 330 can be performed in any order, or can be performed completely or partially in parallel.

B. Business Rules

The step of evaluating the use of business rules, step 220 above, is illustrated in greater detail in FIG. 4. The process begins with step 405. In step 407, information is obtained regarding the use of business rules in the enterprise and in metric generation. This information can include the presence or absence of clear business rules, the degree to which the rules are documented, the consistency of the rules with corporate processes, and whether the rules are reflected in the metric generation process. In an embodiment of the invention, this information can be obtained through keyboard entry or through some other I/O device in response to computerized prompts.

In step 410, points are awarded based on the presence or absence of clear business rules. The presence of such rules merits a higher score because such rules suggest a more reliable metric. In an embodiment of the invention, two point are awarded if there is a set of clear business rules, but no points are given if there is no such set of rules.

In step 420, points are awarded based on the extent of documentation and degree of definition of the business rules. A greater extent of documentation suggests a more reliable metric and therefore merits a higher score. In an embodiment of the invention, one point is awarded if business rules are well-defined, another point is awarded if such rules are documented, but no points are awarded if the business rules are neither well-defined nor documented.

In step 430, points are awarded based on the extent to which business rules are reflected in the method that is used to generate the metric. Actual application of the business rules in the metric generation process suggests a more reliable metric and merits a higher score. In an embodiment of the invention, three points are granted if the business rules are reflected in the method that is used to develop the metric; no points are awarded otherwise.

In step 440, points are awarded based on the consistency of the business rules with corporate strategies and processes. Such consistency suggests a greater degree of reliability for the metric. In an embodiment of the invention, three points are granted if the business rules align with and reflect corporate strategies and processes; no points are awarded otherwise.

In step 445, the scores determined in steps 410 through 440 are summed, creating a factor score for the use of business rules. The process concludes at step 450. Note that in alternative embodiments of the invention, steps 410 through 440 can be performed in any order, or can be performed completely or partially in parallel.

C. Production Process

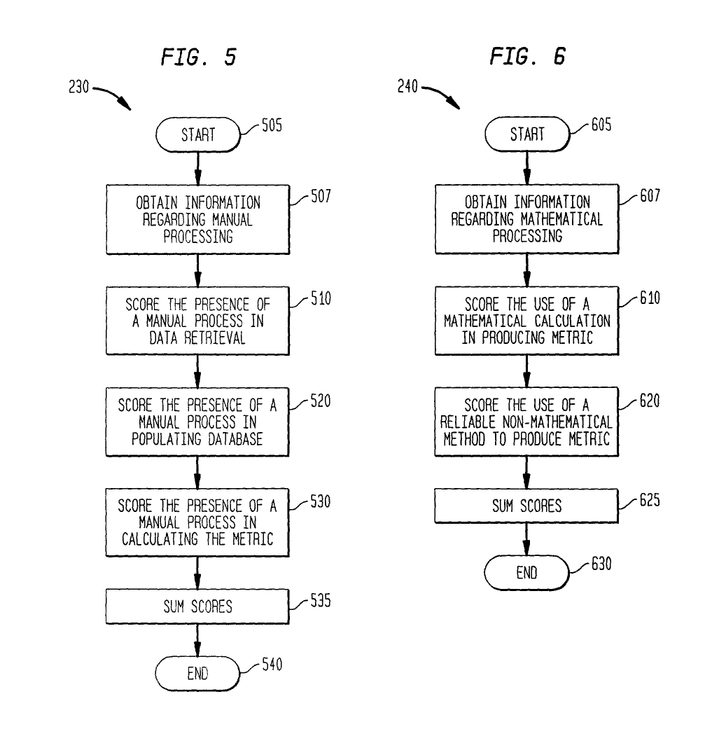

Step 230 above, evaluation of the metric production process, is illustrated in greater detail in FIG. 5. In general, manual processing represents a possible source of error in producing a metric. For this reason, a greater degree of manual processing leads to a lower score. Evaluation begins at step 505. In step 507, information is obtained regarding the metric production process. This information can include the use of manual processing in data retrieval, in population of a data structure, and in calculation of the metric. In an embodiment of the invention, this information can be obtained through keyboard entry or through some other I/O device in response to computerized prompts.

In step 510, points are awarded based on the presence of a manual process in data retrieval. If, for example, the metric is generated using data that is recorded or accessed by hand, a lower score is assigned. In an embodiment of the invention, no points are awarded if manual processing is used in data retrieval; three points are awarded if data retrieval is automated.

In step 520, the use of manual processing in populating a database or other data structure is evaluated. Again, manual population is a possible source of error, leading to a less reliable metric. In an embodiment of the invention, no points are awarded if manual processing is used in database population; four points are awarded if database population is automated.

In step 530, points are awarded based on the use of automation in calculating the metric. Because manual calculation represents a possible source of error, automated calculation leads to a more reliable metric. In an embodiment of the invention, no points are awarded if manual calculation is used; three points are awarded if the calculation is automated.

In step 535, the scores determined in steps 510 through 530 are summed, creating a factor score with respect to the production process. The evaluation concludes at step 540. Note that in alternative embodiments of the invention, steps 510 through 540 can be performed in any order, or can be performed completely or partially in parallel.

D. Mathematical Stability

The step of evaluating the mathematical stability of a metric, step 240 above, is illustrated in greater detail in FIG. 6. In general, a well- defined algorithmic process generates a more reliable metric than a less formal process, and therefore merits a higher score. Ideally, a mathematical calculation is used. This creates a metric in a manner that is relatively precise and reproducible, i.e., mathematically stable. Evaluation with respect to mathematical stability begins with step 605. In step 607, information is obtained regarding the use of mathematical processing in generating the metric. This information can include whether calculation is performed, or whether a non-mathematical process is used. In an embodiment of the invention, this information can be obtained through keyboard entry or through some other I/O device in response to computerized prompts.

In step 610, points are awarded based on whether or not a mathematical calculation is used in generating the metric or any portion of the metric. In an embodiment of the invention, ten points are awarded if there is mathematical calculation that reflects the derivation of the metric; no points are awarded otherwise.

In step 620, points are awarded on the basis of whether a reliable but non-mathematical method is used to derive the metric. Such a process may have some precision, even if it is not mathematical. If so, in an embodiment of the invention, five points are awarded for such a process; no points are awarded otherwise.

In step 625, the scores from steps 610 and 620 are summed to create a factor score for the mathematical stability of the metric. Note that steps 610 and 620 can be performed in a different order, or in parallel, in alternative embodiments of the invention. The process ends at step 630.

E. Integrity

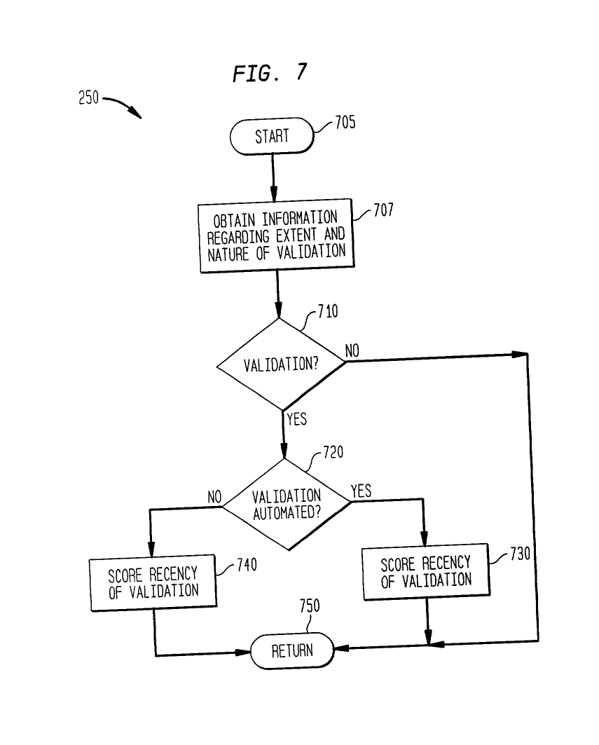

The step of evaluating the integrity of the metric, step 250 above, is illustrated in greater detail in FIG. 7. Generally, a metric can be considered reliable if the data source has a high degree of integrity. Integrity of a data source is established through validation. Validation refers to checks that are made as to the logical and statistical consistency of the data used in creating the data source. For example, if a data source concerns the demographics of retail customers, the percentage of customers older than 18 years of age and the percentage 18 and younger should sum to 100%. If this is not the case, the data is inconsistent and there is clearly an error. One validation check might be to see whether these percentages sum to 100%. Generally, if the data source has been validated, greater reliability is implied. Moreover, if the validation process is automated, then even greater reliability is suggested.

The process of evaluating the integrity of a data source starts at step 705. In step 707, information is obtained regarding the whether validation takes place and whether validation is automated. In an embodiment of the invention, this information can be obtained through keyboard entry or through some other I/O device in response to computerized prompts.

In step 710, a determination is made as to whether or not any validation of the data source has taken place. If not, then the process concludes at step 750 without any points being awarded. If, in step 710, it is determined that validation of the data source has been performed, then the process continues at step 720. Here a determination is made as to whether or not the validation process was automated. If so, then the process continues at step 730. In this step, a factor score is generated based on the recency of the validation. A higher factor score is merited if the validation process was performed recently. If significant time has passed since the most recent validation, a lower factor score is awarded. The process then concludes at step 750.

If, in step 720, it is determined that the validation process is not automated, then the process continues at step 740. Here, a factor score is generated based on the recency of the validation. The process concludes at step 750.

The score for this key factor is therefore generated on the basis of both the automation of the validation process and the recency of the validation. In an embodiment of the invention, the factor score for data integrity is determined as follows:

| Validation | Points awarded |
|---|---|
| Automated, within 30 days | 10 |
| Automated, within 90 days | 9 |
| Automated, within 180 days | 8 |
| Automated, within 9 months | 6 |
| Automated, within a year | 5 |
| Automated, greater than one year | 3 |
| Manual, within 30 days | 8 |
| Manual, within 90 days | 7 |
| Manual, within 180 days | 5 |
| Manual, within 9 months | 3 |
| Manual, within a year | 2 |
| Manual, greater than one year | 1 |
| Never successfully validated | 0 |

F. Supporting Detail

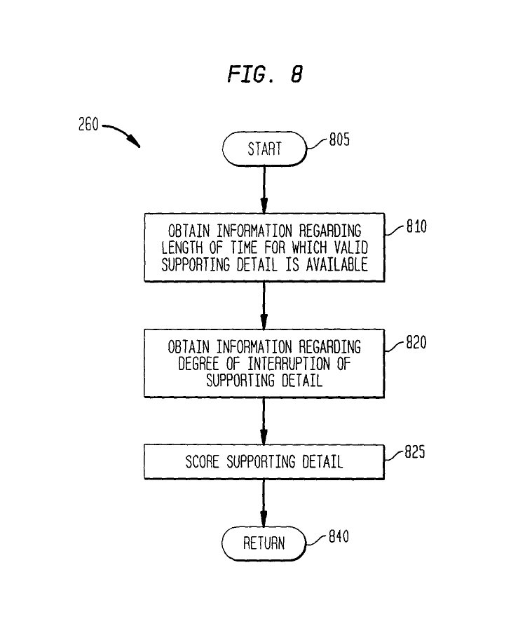

Step 260 above, evaluation of the level of historical supporting detail for the metric, is illustrated in greater detail in FIG. 8. Generally, a metric is more reliable if supporting detail has been available in the past on a relatively uninterrupted basis. Longstanding, regular availability of supporting detail suggests that the supporting detail is reliable, further suggesting the reliability of a metric generated using the supporting detail. A metric relating to operating expenses of a business may, for example, require manpower costs as supporting detail, i.e., a component of expense. Manpower costs may have been generated and recorded on a monthly basis. Manpower costs would therefore represent supporting detail that has been historically generated on a regular basis. If records of manpower costs have not been generated until recently, this suggests that any existing current manpower cost information may be suspect. This casts doubt on the reliability of an overall operating cost metric that is based on the available manpower cost data. Moreover, if records of manpower costs have not been kept regularly, such that there are gaps or interruptions in the historical manpower cost records, this too suggests that existing current manpower cost information may be suspect.

The process of evaluating supporting detail for a metric, according to an embodiment of the invention, starts at step 805. In step 810, information is obtained regarding the length of time for which valid supporting detail is available. In step 820, information is obtained regarding the degree of interruption of the supporting detail. If an organization began generating the supporting detail ten years ago, for example, but there have been interruptions in that interval such that two years worth of data is unavailable, the historical supporting detail is considered to be 80% uninterrupted. In an embodiment of the invention, the information for steps 810 and 820 can be obtained through keyboard entry or through some other I/O device in response to computerized prompts. Alternatively, if the information for steps 810 and 820 is archived in a memory medium, the information can be accessed through a network connection or other automated means.

Based on these determinations, a factor score is determined in step 825. A higher factor score is merited for more historical supporting detail and for less interruption. In an embodiment of the invention, the factor score is determined as follows:

| Supporting detail | Points |
|---|---|
| 3 years supporting, valid, | 10 |
| uninterrupted supporting detail | |
| 3 years supporting, valid, 90% | 9 |
| uninterrupted supporting detail | |
| 2 years supporting, valid, | 8 |
| uninterrupted supporting detail | |
| 2 years supporting, valid, 90% | 7 |
| uninterrupted supporting detail | |
| 1 year supporting, valid, | 6 |
| uninterrupted supporting detail | |
| 1 year supporting, valid, 90% | 5 |
| uninterrupted supporting detail | |
| <1 year supporting, valid, | 4 |
| uninterrupted supporting detail | |
| 3 years supporting, valid, <90% | 3 |
| uninterrupted supporting detail | |
| 2 years supporting, valid, <90% | 2 |
| uninterrupted supporting detail | |
| 1 year supporting, valid, <90% | 1 |
| uninterrupted supporting detail | |
| <1 year supporting, valid, | 1 |
| uninterrupted supporting detail | |
| No supporting, valid, uninterrupted | 0 |
| supporting detail | |

Process 260 concludes at step 840.

G. Final Weighted Numerical Assessment

As described above, the overall metric assessment process concludes by combining all the factor scores together (step 120). The result is a composite numerical assessment of the reliability of the metric. In an embodiment of the invention, the final process is a weighted and quantitative summation of all the factor scores. The final numerical assessment in this embodiment is therefore a weighted sum of all factor scores.

Using the exemplary point values mentioned above, the final weighted numerical assessment of the metric will range from zero and 100. In an embodiment of the invention, this value can be interpreted as follows:

| Final weighted numerical | |
|---|---|
| assessment | Interpretation |
| 93-100 | Metric is stable and valid. Use is |
| | recommended. |
| 87-92 | Minor questions regarding validity. |
| | Use is recommended. |
| 81-86 | Metric needs work, but is fairly |
| | reliable. Use is questioned; consider |
| | corporate need and impact. |
| 75-80 | Substantial work needed in one or |
| | two areas. Reliability in question. |
| | Use is not recommended and should |
| | be closely guarded. |
| 70-74 | Major work needed in one or more |
| | areas. Reliability in question. Use |
| | is not recommended and should be |
| | closely guarded. |
| <70 | Metric is unstable. No real validity |
| | or reliability. Should not be used. |

IV. Computing Environment

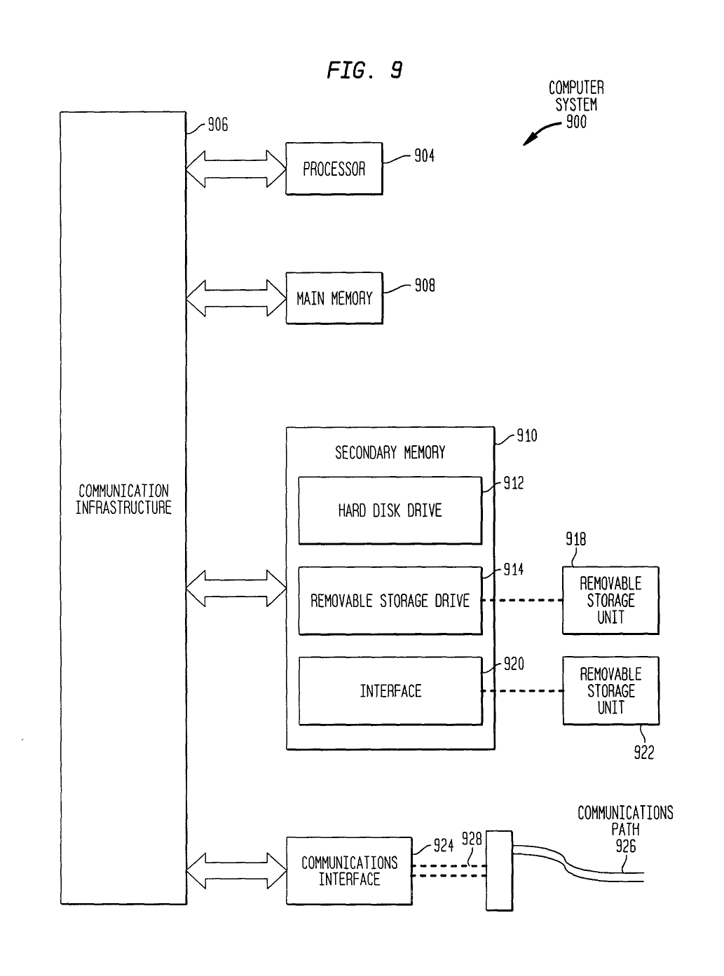

A system for assessing a metric may be implemented using hardware, software or a combination thereof and may be implemented in a computer system or other processing system. An example of such a computer system 900 is shown in FIG. 9. The computer system 900 includes one or more processors, such as processor 904. The processor 904 is connected to a communication infrastructure 906 (e.g., a bus or network). Various software embodiments can be described in terms of this exemplary computer system. After reading this description, it will become apparent to a person skilled in the relevant art how to implement the invention using other computer systems and/or computer architectures.

Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well known manner. Removable storage unit 918 represents a floppy disk, magnetic tape, optical disk, etc. As will be appreciated, the removable storage unit 918 includes a computer usable storage medium having stored therein computer software and/or data.

Secondary memory 910 can also include other similar means for allowing computer programs or input data to be loaded into computer system 900. Such means may include, for example, a removable storage unit 922 and an interface 920. Examples of such may include a program cartridge and cartridge interface (such as that found in video game devices), a removable memory chip (such as an EPROM, or PROM) and associated socket, and other removable storage units 922 and interfaces 920 which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a PCMCIA slot and card, etc. Software and data transferred via communications interface 924 are in the form of signals 928 which may be electronic, electromagnetic, optical or other signals capable of being received by communications interface 924. These signals 928 are provided to communications interface 924 via a communications path (i.e., channel) 926. This channel 926 carries signals 928 into and out of computer system 900, and may be implemented using wire or cable, fiber optics, a phone line, a cellular phone link, an RF link and other communications channels. In an embodiment of the invention, signals 928 can convey the information required to assess a metric, such as the information described above with respect to steps 307,407,507,607,707, 810, and 820. This information, embodied in incoming signals 928, represent input to the metric assessment process. Outgoing signals 928 can include user prompts to solicit inputs. Outgoing signals 928 can also include the final weighted numerical assessment of a metric.

In this document, the terms “computer program medium” and “computer usable medium” are used to generally refer to media such as removable storage drive 914, a hard disk installed in hard disk drive 912, and signals 928. These computer program products are means for providing software to computer system 900. The invention is directed to such computer program products.

Computer programs (also called computer control logic) are stored in main memory 908 and/or secondary memory 910. Computer programs may also be received via communications interface 924. Such computer programs, when executed, enable the computer system 900 to perform the features of the present invention as discussed herein. In particular, the computer programs, when executed, enable the processor 904 to perform the features of the present invention. Accordingly, such computer programs represent controllers of the computer system 900.

V. Conclusion

While various embodiments of the present invention have been described above, it should be understood that they have been presented by way of example, and not limitation. It will be apparent to persons skilled in the relevant art that various changes in detail can be made therein without departing from the spirit and scope of the invention. Thus the present invention should not be limited by any of the above-described exemplary embodiments, but should be defined only in accordance with the following claims and their equivalents.

What is claimed is:

1. A method of assessing the reliability of a metric, comprising the steps of:
(a) evaluating the metric with respect to each of at least one key factor to produce a factor score for each key factor; and
(b) when there is more than one factor score, combining the factor scores to form a final weighted numerical assessment for the metric.

2. The method of claim 1, wherein said step (a) comprises the step of evaluating the metric with respect to a source of data that is used in developing the metric.

3. The method of claim 2, wherein said step of evaluating the metric with respect to the source of data comprises the steps of:
i) scoring the number of run failures over a previous predetermined interval of time;
ii) scoring the number of system failures over the interval;
iii) scoring the number of partial runs over the interval; and
iv) summing the scores for the run failures, system failures, and partial runs, to form a data source factor score.

4. The method of claim 1, wherein said step (a) comprises the step of evaluating the metric with respect to business rules used in developing the metric.

5. The method of claim 4, wherein said step of evaluating the metric with respect to business rules comprises the steps of:
i) scoring the presence of clear business rules;
ii) scoring the extent of definition and documentation of business rules;
iii) scoring the extent to which a method used to develop the metric reflects the business rules;
iv) scoring the consistency of the business rules with corporate strategies and processes; and
v) summing the scores from said steps i) through iv) to form a business rules factor score.

6. The method of claim 1, wherein said step (a) comprises the step of evaluating the process used in the production of the metric.

7. The method of claim 6, wherein said step of evaluating the process used in the production of the metric comprises the steps of:
i) scoring the presence of manual processing in retrieving data used to produce the metric;
ii) scoring the presence of manual processing in populating a data structure;
iii) scoring the presence of manual processing in determining the metric; and
iv) summing the scores from said steps i) through iii) to form a manual processing factor score.

8. The method of claim 1, wherein said step (a) comprises the step of evaluating the metric with respect to mathematical stability of the metric.

9. The method of claim 8, wherein said step of evaluating the metric with respect to mathematical stability comprises the steps of:
i) scoring the use of a mathematical calculation to derive the metric; and
ii) scoring the use of a reliable non-mathematical method to derive the metric; and
iii) summing the scores from said steps i) and ii) to form a mathematical stability factor score.

10. The method of claim 1, wherein said step (a) comprises the step of evaluating the metric with respect to integrity of a data source.

11. The method of claim 10, wherein said step of evaluating the metric with respect to integrity of the data source comprises the steps of:
i) determining whether the data source has been validated;
ii) if the data source has been validated, scoring the recency and automation of the validation to form an integrity factor score; and
iii) if the data source has not been validated, assigning the value of zero as the integrity factor score.

12. The method of claim 1, wherein said step (a) comprises the step of evaluating the metric with respect to supporting detail for the metric.

13. The method of claim 12, wherein said step of evaluating the metric with respect to supporting detail comprises the steps of:
i) determining a length of time for which valid supporting historical detail has been available;
ii) determining a degree of interruption of the valid supporting historical detail; and
iii) scoring, in aggregate, the length of time for which valid supporting historical detail is available and the degree of interruption of the valid supporting historical detail, to form a supporting detail factor score.

14. The method of claim 1, wherein said step (b) comprises the step of adding together the at least one factor score to form the final weighted numerical assessment of the metric.

15. A computer program product comprising a computer usable medium having computer readable program code means embodied in said medium for causing an application program to execute on a computer to assess the reliability of a metric, said computer readable program code means comprising:
(a) first computer readable program code means for causing the computer to evaluate the metric with respect to each of at least one key factor to produce a factor score for each key factor; and
(b) second computer readable program code means for causing the computer to, when there is more than one factor score, combine the factor scores to form a final weighted numerical assessment for the metric.

16. The computer program product of claim 15, wherein said first computer readable program code means comprises computer readable program code means for evaluating the metric with respect to a source of data that is used in developing the metric.

17. The computer program product of claim 16, wherein said computer readable program code means for evaluating the metric with respect to the source of data comprises:
i) computer readable program code means for scoring the number of run failures over a previous predetermined interval of time;
ii) computer readable program code means for scoring the number of system failures over the interval;
iii) computer readable program code means for scoring the number of partial runs over the interval; and
iv) computer readable program code means for summing the scores for the run failures, system failures, and partial runs, to form a data source factor score.

18. The computer program product of claim 15, wherein said first computer readable program code means comprises computer readable program code means for evaluating the metric with respect to business rules used in developing the metric.

19. The computer program product of claim 18, wherein said computer readable program code means for evaluating the metric with respect to business rules comprises:
i) computer readable program code means for scoring the presence of clear business rules;
ii) computer readable program code means for scoring the extent of definition and documentation of business rules;
iii) computer readable program code means for scoring the extent to which a method used to develop the metric reflects the business rules;
iv) computer readable program code means for scoring the consistency of the business rules with corporate strategies and processes; and
v) computer readable program code means for summing the scores from said computer readable program code means i) through iv), to form a business rules factor score.

20. The computer program product of claim 15, wherein said first computer readable program code means comprises computer readable program code means for evaluating the metric with respect to a process used in producing the metric.

21. The computer program product of claim 20, wherein said computer readable program code means for evaluating the metric with respect to the process used in producing the metric comprises:
i) computer readable program code means for scoring the presence of manual processing in retrieving data used to produce the metric;
ii) computer readable program code means for scoring the presence of manual processing in populating a data structure;
iii) computer readable program code means for scoring the presence of manual processing in determining the metric; and
iv) computer readable program code means for summing the scores from said steps i) through iii) to form a metric production process factor score.

22. The computer program product of claim 15, wherein said first computer readable program code means comprises computer readable program code means for evaluating the metric with respect to mathematical stability of the metric.

23. The computer program product of claim 22, wherein said computer readable program code means for evaluating the metric with respect to mathematical stability comprises:
i) computer readable program code means for scoring the use of a mathematical calculation to derive the metric; and
ii) computer readable program code means for scoring the use of a reliable non-mathematical method to derive the metric; and
iii) computer readable program code means for summing the scores from said steps i) and ii) to form a mathematical stability factor score.

24. The computer program product of claim 15, wherein said first computer readable program code means comprises computer readable program code means for evaluating the metric with respect to integrity of the data source.

25. The computer program product of claim 24, wherein said computer readable program code means for evaluating the metric with respect to integrity of the data source comprises:
i) computer readable program code means for scoring the recency and automation of the validation to form an integrity factor score if the data source has been validated; and
ii) computer readable program code means for assigning the value of zero as the integrity factor score if the data source has not been validated.

26. The computer program product of claim 15, wherein said first computer readable program code means comprises computer readable program code means for evaluating the metric with respect to supporting detail for the metric.

27. The computer program product of claim 26, wherein said computer readable program code means for evaluating the metric with respect to supporting detail comprises computer readable program code means for scoring, in aggregate, the length of time for which valid supporting historical detail has been available and the degree of interruption of the valid supporting historical detail, to form a supporting detail factor score.

28. The computer program product of claim 15, wherein said second computer readable program code means comprises computer readable program code means for adding together the at least one factor score to form the final weighted numerical assessment of the metric.

29. A system for assessing the reliability of a metric, comprising:
(a) means for receiving an evaluation of the metric with respect to each of at least one key factor;
(b) means for producing a factor score for each key factor; and
(c) where there is more than one factor score, means for combining the factor scores to form a final weighted numerical assessment for the metric.
